(19) United States
(12) Patent Application Publication
(10) Pub. No.: US 2024/0140510 A1
(43) Pub. Date: May 2, 2024

(54) UTILITY CART DEVICE

(71) Applicant: Justin Minchen, Buffalo, NY (US)

(72) Inventor: Justin Minchen, Buffalo, NY (US)

(21) Appl. No.: 18/453,523

(22) Filed: Aug. 22, 2023

Related U.S. Application Data
(60) Provisional application No. 63/421,742, filed on Nov. 2, 2022.

(51) Int. Cl. B62B 3/00; B62B 3/04

(52) U.S. Cl. CPC B62B 3/005; B62B 3/04; B62B 2203/30

(57) ABSTRACT

A utility cart device is provided. The device is comprised of a body, a top shelf, and at least one storage container. The top shelf is comprised of a top surface that removably attaches to at least one storage container. The storage containers provide a means of organizing and storing construction or industrial equipment or parts to expedite construction or industrial work. The storage containers may be removed from the top surface to be used in a construction or industrial work area.

### CROSS-REFERENCE TO RELATED APPLICATION

The present application claims priority to, and the benefit of, U.S. Provisional Application No. 63/421,742, which was filed on Nov. 2, 2022, and is incorporated herein by reference in its entirety.

### FIELD OF THE INVENTION

The present invention relates generally to the field of utility carts. More specifically, the present invention relates to a utility cart device with at least one shelf having at least one removable storage container that organizes and stores tools, parts, or other utility items known in the art. Accordingly, the present disclosure makes specific reference thereto. Nonetheless, it is to be appreciated that aspects of the present invention are also equally applicable to other like applications, devices, and methods of manufacture.

### BACKGROUND

When working in a construction or industrial environment, standard utility carts offer convenience for storing equipment, parts, or tools while on the job. However, standard utility carts cannot organize the equipment or tools on the cart itself. The lack of organization causes significant frustration when trying to locate a specific piece of equipment, part, or tool to use while performing construction or industrial tasks. Additionally, user frustration may lead to material and equipment waste because it often saves time to throw away the extra equipment or parts that are preventing a user from finding the correct item instead of replacing the equipment or parts in their original packaging.

Therefore, there exists a long-felt need in the art for a device that organizes and stores construction or industrial equipment, parts, or tools. More specifically, there exists a long-felt need in the art for a utility cart device that is comprised of removable storage containers providing a user with optimal storage and organization for construction equipment, parts, or tools. Furthermore, there exists a long-felt need in the art for a utility card device that is comprised of removable storage containers providing a user with optimal storage and organization for construction equipment, parts, or tools wherein the device can be universally applied to any construction or industrial setting.

The subject matter disclosed and claimed herein, in one embodiment thereof, comprises a utility cart device. The device is comprised of a body with at least one wheel and at least one handle for maneuvering. Additionally, the utility cart device is comprised of at least one top shelf that may attach to at least one storage container. Furthermore, the storage container is comprised of an interior space that allows equipment, parts, tools, or other items known in the art to be organized and stored within the storage container. The device may also be comprised of at least one bottom shelf that may be comprised of any features of the top shelf for further organization and storage. The body of the device may also be comprised of a fastener that provides an attachment point for a ladder, shovel, hose, or another piece of equipment known in the art.

In this manner, the utility cart device of the present invention accomplishes all the foregoing objectives and provides a device that organizes and stores construction or industrial equipment, parts, or tools. More specifically, the utility cart device provides removable storage containers that optimally organize and store equipment, parts, or tools for everyday use on a job site. Furthermore, the device can be universally applied to any construction or industrial setting.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a utility cart device. The device is comprised of at least one handle that allows a user an area of the device to grasp while moving and transporting the device. The handle may be any shape known in the art, but preferably an ergonomic shape that provides optimal gripping by a user. The body of the device is also comprised of at least one wheel. The wheel rotates 360 degrees and allows maneuverability with minimal user effort or fatigue.

Additionally, the device is comprised of at least one top shelf. The top shelf comprises a top surface that stores and supports at least one storage container. The top surface is a designated area that stores, supports, and organizes at least one storage container, at least one tool bag, or any other piece of equipment known in the art.

The top surface may vary in a plurality of embodiments. In one embodiment, the top surface is comprised of at least one fastener. The fastener removably fixes at least one storage container to a top surface of a top shelf. The fastener may be any fastener known in the art, such as, but not limited to, a magnet, hook and loop fastener, snap button fastener, etc.

In another embodiment, the top surface may be comprised of non-slip rubber, foam, silicon, etc., material that prevents at least one storage container from moving during the use of the device.

In a further embodiment, the top surface is also comprised of at least one grip area. The grip area allows further organization and storage of construction or industrial equipment. In one embodiment, the grip area may be comprised of non-slip rubber, foam, silicon, etc., material preventing equipment from moving during the use of the device. In another embodiment, the grip area may be any other surface known in the art, such as, but not limited to, metal, plastic, wood, etc.

Alternatively, the top surface may be comprised of a metal that removably attaches to at least one fastener of at least one storage container, wherein said fastener is a magnet. In another embodiment, the top surface may be comprised of at least one non-removable storage container with dividers to organize and store equipment, parts, tools, etc.

Additionally, the device is comprised of at least one storage container. The storage container stores and organizes construction or industrial equipment. The storage container may be any size, shape, or depth that permits optimal storage of said equipment. The storage container may be made from any material known in the art, such as, but not limited to, wood, metal, plastic, etc. In the preferred embodiment of the device, at least one storage container forms an interlocking, grid-like pattern with at least one other storage container to promote the organization and storage of said equipment. In one embodiment, the pattern of at least one storage container may encompass the entirety of a top surface of a top shelf. However, in another embodiment, the pattern of at least one storage container may encompass any area less than the entirety of a top surface of a top shelf.

The storage container is further comprised of at least one bottom surface. The bottom surface removably attaches to a top surface of a top shelf. In one embodiment, the bottom surface removably attaches to a top surface of a top shelf via at least one fastener. The fastener may be any fastener known in the art, such as, but not limited to, a magnet, hook and loop fastener, snap button fastener, etc. In another embodiment, the bottom surface is comprised of a metal that removably attaches to a fastener of a top surface, wherein the fastener is a magnet.

The storage container is also comprised of at least one side surface. The side surface of at least one storage container attaches to the side surface of at least one other storage container via at least one fastener. The fastener removably attaches the side surfaces of at least one storage container to form an interlocking, grid-like pattern. The fastener may be any fastener known in the art, such as, but not limited to, a magnet, hook and loop fastener, snap button fastener, etc. Moreover, the storage container is comprised of at least one interior space. A user stores and organizes construction or industrial equipment or parts in the interior space of at least one storage container.

The present invention is also comprised of a method of using the device. First, a device is provided comprised of a body, at least one top shelf, and at least one storage container. Then, a user places at least one storage container on a top surface of a top shelf. Next, a user loads construction or industrial equipment, parts, tools, or other items known in the art into at least one interior space of at least one storage container. Then, a user removes at least one storage container comprised of said parts to bring to a construction or industrial work area for use of said parts.

The present invention is also comprised of a second method of using the device. First, a device is provided comprised of a body, at least one top shelf, and at least one storage container. Then, a user places at least one storage container on a top surface of a top shelf via at least one fastener of a storage container and at least one fastener of a top surface. Next, a user loads construction or industrial equipment, parts, tools, or other items known in the art into at least one interior space of a storage container. Then, a user removes at least one storage container comprised of said parts to bring to a construction or industrial work area for use of said parts.

Accordingly, the utility cart device of the present invention is particularly advantageous as it provides a device that can optimally store construction or industrial equipment, parts, or tools. More specifically, the device is comprised of removable storage containers for organizing and storing equipment, parts, or tools. Furthermore, the device can be universally applied to any construction or industrial setting. Thus, the utility cart device provides a universal solution to construction or industrial site equipment, parts, or tool clutter that may lead to waste. In this manner, the utility cart device overcomes the limitations of existing headstones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a utility cart device of the present invention in accordance with the disclosed architecture;

FIG. 2 illustrates a side view of one potential embodiment of a utility cart device of the present invention in accordance with the disclosed architecture;

FIG. 3 illustrates a perspective view of one potential embodiment of a utility cart device of the present invention in accordance with the disclosed architecture;

FIG. 4 illustrates a flowchart of a method of using one potential embodiment of a utility cart device of the present invention in accordance with the disclosed architecture; and

FIG. 5 illustrates a flowchart of a method of using one potential embodiment of a utility cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that organizes and stores construction or industrial equipment, parts, or tools. More specifically, there exists a long-felt need in the art for a utility cart device that is comprised of removable storage containers providing a user with optimal storage and organization for construction equipment, parts, or tools. Furthermore, there exists a long-felt need in the art for a utility card device that is comprised of removable storage containers providing a user with optimal storage and organization for construction equipment, parts, or tools wherein the device can be universally applied to any construction or industrial setting.

The present invention, in one exemplary embodiment, is comprised of a utility cart device. A body of the device is comprised of at least one handle. During use, a user may grasp the handle of the device to move the utility cart device around a construction or industrial work environment. In general, the handle is a shape that provides optimal gripping. However, it may be any shape known in the art. Additionally, the body is comprised of at least one wheel. The wheel rotates 360 degrees to provide a means of moving the device around a construction or industrial work site.

Moreover, the device is comprised of at least one top shelf. The top shelf is comprised of at least one top surface. The top surface of a top shelf supports at least one storage container or another piece of equipment known in the art. In one embodiment, the top surface may be a metal material that attaches to at least one fastener of at least one storage container, wherein the fastener of a storage container is a magnet. Additionally, in another embodiment, the top surface may be a non-slip material, such as, but not limited to, rubber, foam, silicon, etc., that prevents at least one storage container from sliding during the use of the device. In another embodiment, the top surface is comprised of at least one fastener. The fastener removably attaches at least one storage container to a top surface. The fastener may be any fastener known in the art, such as, but not limited to, a magnet, hook and loop fastener, snap button fastener, etc. Furthermore, in another embodiment, the top surface may comprise at least one non-removable storage container with dividers to organize and store construction equipment.

The top surface is further comprised of at least one grip area. The grip area organizes and stores construction or industrial equipment that is not stored in a storage container. The grip area may be comprised of a plurality of materials known in the art in various embodiments, such as, but not limited to, metal, plastic, rubber, silicon, etc.

The device is also comprised of at least one storage container. The storage container organizes and stores construction or industrial equipment, parts, tools, etc. The storage container may be any shape, size, depth, pattern, or design that optimizes the storage and organization of said equipment. Furthermore, the storage containers may encompass any amount of space on a top surface, such as, but not limited to, the entirety or anything less than the entirety of the top surface. In the preferred embodiment, at least one storage container forms an interlocking, grid-like structure to organize and store said equipment.

The storage container is also comprised of at least one bottom surface. The bottom surface removably joins with a top surface of a top shelf. In one embodiment, the bottom surface attaches to a top surface via at least one fastener. The fastener may be any fastener known in the art, such as, but not limited to, a magnet, hook and loop fastener, snap button fastener, etc. In another embodiment, the bottom surface may be comprised of a metal that removably attaches to a fastener of a top surface, wherein the fastener of a top surface is a magnet.

Additionally, the storage container is comprised of at least one side surface. The side surface removably attaches to at least one side surface of another storage container via at least one fastener to form an interlocking, grid-like pattern. The fastener may be any fastener known in the art, such as, but not limited to, a magnet, hook and loop fastener, snap button fastener, etc. Furthermore, the storage container is comprised of at least one interior space. Construction or industrial equipment, parts, tools, etc., are stored and organized in the interior space of at least one storage container.

The present invention is also comprised of a method of using the device. First, a device is provided comprised of a body, at least one top shelf, and at least one storage container. Then, a user places at least one storage container on a top surface of a top shelf. Next, a user loads construction or industrial equipment, parts, tools, or other items known in the art into at least one interior space of at least one storage container. Then, a user removes at least one storage container comprised of said parts to bring to a construction or industrial work area for use of said parts.

The present invention is also comprised of a second method of using the device. First, a device is provided comprised of a body, at least one top shelf, and at least one storage container. Then, a user places at least one storage container on a top surface of a top shelf via at least one fastener of a storage container and at least one fastener of a top surface. Next, a user loads construction or industrial equipment, parts, tools, or other items known in the art into at least one interior space of a storage container. Then, a user removes at least one storage container comprised of said parts to bring to a construction or industrial work area for use of said parts.

Accordingly, the utility cart device of the present invention is particularly advantageous as it provides a device that can optimally store construction or industrial equipment, parts, or tools. More specifically, the device is comprised of removable storage containers for organizing and storing equipment, parts, or tools. Furthermore, the device can be universally applied to any construction or industrial setting. Thus, the utility cart device provides a universal solution to construction or industrial site equipment, parts, or tool clutter that may lead to waste. In this manner, the utility cart device overcomes the limitations of existing headstones known in the art.

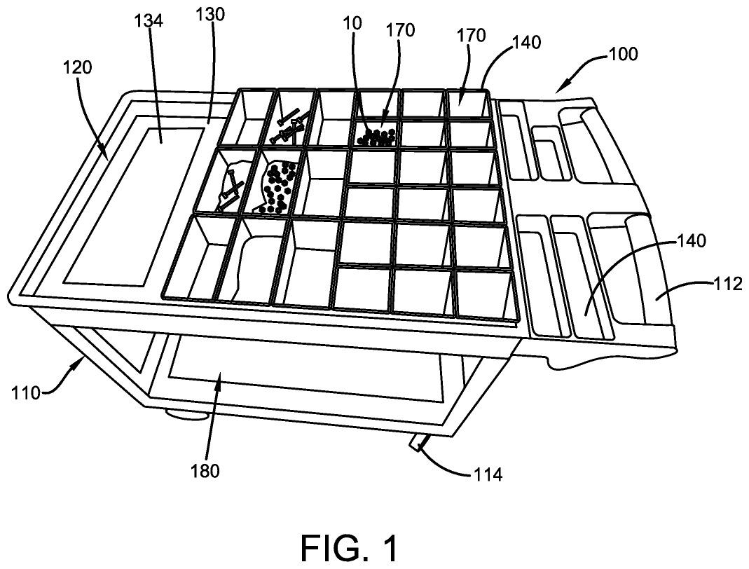

Referring initially to the drawings, FIG. 1 illustrates a perspective view of a body 110 of one potential embodiment of a utility cart device 100 of the present invention in accordance with the disclosed architecture. The body 110 is comprised of at least one handle 112. The handle 112 provides a user with an area of the body 110 to grasp while maneuvering the device 100. Additionally, the handle 112 is, in general, an ergonomic shape that provides a user with optimal gripping. However, the handle 112 may be any shape known in the art, such as, but not limited to, cylindrical, rectangular, etc.

Furthermore, the body 110 of the device 100 is also comprised of at least one wheel 114. The wheel 114 rotates 360 degrees (around a vertical axis) and allows the device 100 to be moved with minimal user effort or fatigue. The wheel 114 may be made from any material known in the art, such as, but not limited to, polyurethane, rubber, thermoplastic rubber, polyolefin, phenolic resin, etc.

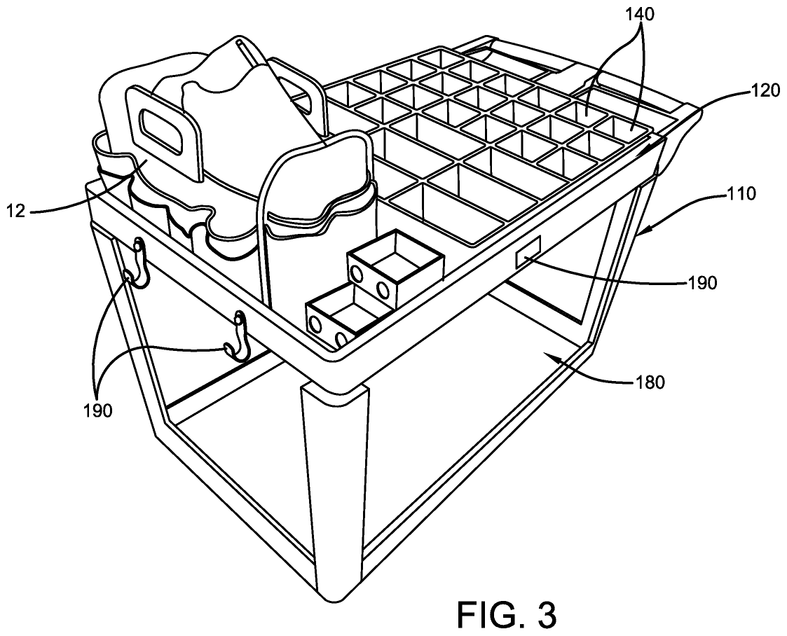

The device 100 is further comprised of at least one top shelf 120. The top shelf 120 has a top surface 130 that supports at least one storage container 140. The top surface 130 is a multipurpose area that supports, stores, and organizes at least one storage container 140, at least one tool bag 12, or any other piece of equipment known in the art, as seen in FIG. 3.

The top surface 130 may vary in a plurality of embodiments. In one embodiment, the top surface 130 is comprised of at least one fastener 132. The fastener 132 removably attaches to at least one storage container 140 and affixes said container 140 to the top surface 130 in a removable fashion. The fastener 132 may be any fastener known in the art, such as, but not limited to, a magnet, hook and loop fastener, snap button fastener, an adhesive fastener, etc.

In another embodiment, the top surface 130 may be comprised of a non-slip material that prevents at least one storage container 140 from shifting, sliding, or moving during the use or movement of the device 100 but does not secure a storage container 140 via at least one fastener 132. The non-slip material may be any material known in the art, such as, but not limited to, rubber, silicone, foam, etc.

In a similar embodiment, only a portion of the top surface 130 is comprised of at least one grip area 134. The grip area 134 provides a supplementary space to organize and store construction or industrial equipment, parts 10, tools, or other items known in the art without storing said items in a storage container 140. In one embodiment, the grip area 134 may be comprised of a non-slip material to prevent tools from shifting, sliding, or moving during use or transport of the device 100. The non-slip material may be any material known in the art, such as, but not limited to, rubber, silicone, foam, etc. In another embodiment, the grip area 134 may be any other surface material known in the art, such as, but not limited to, plastic, metal, wood, etc.

In another embodiment, the top surface 130 may be comprised of a metal surface. The metal surface may attach to at least one fastener 152 of at least one storage container 140 in an embodiment where a fastener 152 is a magnet. In another embodiment, the container 140 may be magnetic to magnetically attached to the top surface 130.

Furthermore, in another embodiment of the utility cart device 100, the top surface 130 may be comprised of at least one non-removable storage container 140 with dividers for construction equipment, parts 10, tools, or other items known in the art.

The device 100 is comprised of at least one storage container 140. The storage container 140 stores and organizes construction or industrial equipment, parts 10, tools, or other items known in the art. The storage container 140 may be any shape, size, or depth to optimally store and organize said construction or industrial items. Additionally, the storage container 140 may be made from any material known in the art, such as, but not limited to, wood, plastic, metal, glass, ceramic, etc.

In the preferred embodiment, at least one storage container 140 forms an interlocking, grid-like structure that promotes organization and prevents container 140 movement during the use or transport of the utility cart device 100. Moreover, the storage container 140 may be any design, arrangement, or quantity that allows a user to optimally fit any construction or industrial equipment. In one embodiment, the storage container 140 may encompass the entirety of the top surface 130. In another embodiment, the storage container 140 may encompass any area less than the entirety of the top surface 130 to allow for the storage of tools bags or other various large tools, parts, etc.

The storage container 140 is also comprised of at least one bottom surface 150. The bottom surface 150 removably adjoins with a top surface 130 of a top shelf 120. In one embodiment, the bottom surface 150 is comprised of at least one fastener 152. The fastener 152 removably fixes at least one storage container 140 to a top shelf 120. The fastener 152 may be any fastener known in the art, such as, but not limited to, a magnet, hook and loop fastener, snap button fastener, an adhesive fastener, etc. In another embodiment, the bottom surface 150 is comprised of a metal that removably attaches to at least one fastener 132 of a top surface 130 wherein a fastener 132 is a magnet.

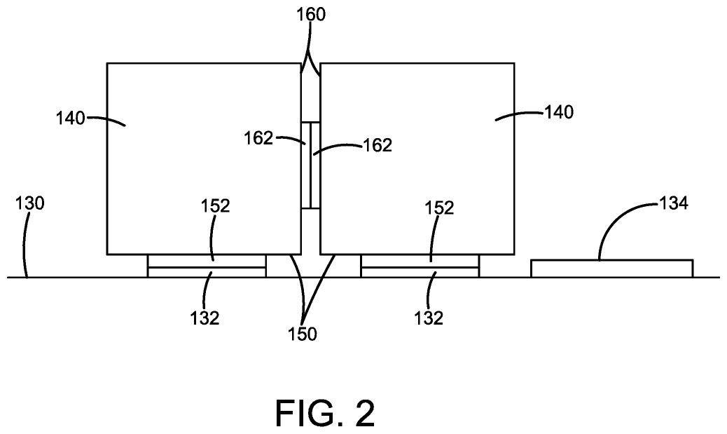

Furthermore, the storage container 140 is comprised of at least one side surface 160. The side surface 160 of at least one storage container 140 adjoins at least one side surface 160 of a second storage container 140 via at least one fastener 162, as seen in FIG. 2. The fastener 162 removably interlocks at least one storage container 140 in the preferred, grid-like pattern. The fastener 162 may be any fastener known in the art, such as, but not limited to, a magnet, hook and loop fastener, snap button fastener, an adhesive fastener, etc. The storage container 140 is also comprised of at least one interior space 170. Construction or industrial equipment, parts 10, tools, or other items known in the art are stored and organized inside the interior space 170.

The device 100 is also comprised of at least one bottom shelf 180 for additional storage space. The bottom shelf 180 may be a plurality of embodiments. In one embodiment, the bottom shelf 180 is comprised of any of the features of a top shelf 120 mentioned supra. In another embodiment, the bottom shelf 180 may be a standard shelf for storing construction or industrial equipment, parts 10, tools, or other items known in the art without organizational structures. Moreover, the device 100 is comprised of at least one fastener 190. The fastener 190 provides a user with an area on a utility cart device 100 to store equipment such as, but not limited to, a ladder, level, shovel, etc. The fastener 190 may be attached to any part of a body 110 of a device 100. Additionally, the fastener 190 may be any fastener known in the art, such as, but not limited to, an eye hook, swivel hook, clevis hook, clip, carabiner, etc.

In one embodiment, the device 100 may be in the form of a kit that can be applied to any utility cart. The kit preferably includes (but is not limited to): at least one storage container 140 which may or may not have at least one fastener 152,162 on the bottom surface 150 or side surface 160 of the container 140, and at least one grip area 134 that also may be comprised of at least one fastener 132 that attaches to the fastener 152 of the bottom surface 150 of the container 140.

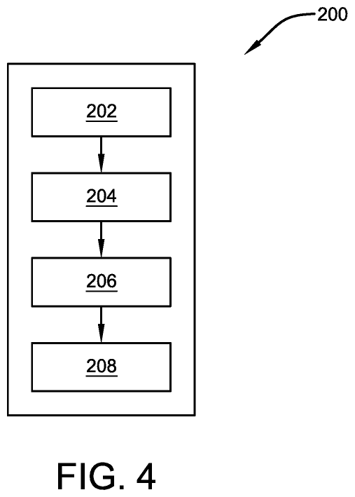

The present invention is also comprised of a method of using 200 the device 100, as seen in FIG. 4. First, a device 100 is provided comprised of a body 110, at least one top shelf 120, and at least one storage container 140 [Step 202]. Then, a user places at least one storage container 140 on a top surface 130 of a top shelf 120 [Step 204]. Next, a user loads construction or industrial equipment, parts 10, tools, or other items known in the art into at least one interior space 170 of the storage container 140 [Step 206]. Then, a user removes at least one storage container 140 comprised of said parts 10 to bring to a construction or industrial work area for use of said parts 10 [Step 208].

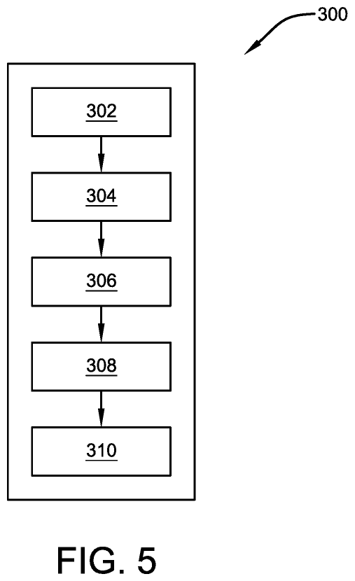

The present invention is also comprised of a second method of using 300 the device 100, as seen in FIG. 5. First, a device 100 is provided comprised of a body 110, at least one top shelf 120, and at least one storage container 140 [Step 302]. Then, a user places at least one storage container 140 on a top surface 130 of a top shelf 120 via at least one fastener 152 of a storage container 140 and at least one fastener 132 of a top surface 130 [Step 304]. Optionally, the first container 140 and the second container 140 can further be attached to each other via fasteners 162 of each side surface 160 of each container 140 [Step 306]. Next, a user loads construction or industrial equipment, parts 10, tools, or other items known in the art into at least one interior space 170 of at least one storage container 140 [Step 308]. Then, a user removes at least one storage container 140 comprised of said parts 10 to bring to a construction or industrial work area for use of said parts 10 [Step 310].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “utility cart device” and “device” are interchangeable and refer to the utility cart device 100 of the present invention.

Notwithstanding the foregoing, the utility cart device 100 of the present invention and its various components can be of any suitable size and configuration as is known in the art without affecting the overall concept of the invention, provided that they accomplish the above-stated objectives. One of ordinary skill in the art will appreciate the size, configuration, and material of the utility cart device 100 as shown in the FIGS. are for illustrative purposes only, and that many other sizes and shapes of the utility cart device 100 are well within the scope of the present disclosure. Although the dimensions of the utility cart device 100 are important design parameters for user convenience, the utility cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A utility cart device comprising:
a wheel;
a top shelf comprised of a top surface; and
a storage container positioned on the top surface.

2. A utility cart device of claim 1, wherein the top surface is comprised of a magnetic fastener.

3. A utility cart device of claim 2, wherein the storage container is comprised of a magnetic container.

4. A utility cart device of claim 1, wherein the top surface is comprised of a non-slip material.

5. A utility cart device of claim 1, wherein a portion of the top surface is comprised of a grip area.

6. A utility cart device of claim 5, wherein the grip area is comprised of a non-slip material.

7. A utility cart device of claim 1 further comprised of a handle.

8. A utility cart device of claim 1, wherein the storage container is fixedly attached to the top surface.

9. A utility cart device of claim 1 further comprised of a bottom shelf.

10. A utility cart device of claim 1, wherein a body of the utility cart device is comprised of a body fastener.

11. A utility cart device of claim 10, wherein the body fastener is comprised of a hook.

12. A utility cart device comprising:
a wheel;
a top shelf comprised of a top surface, the top surface comprised of a first fastener; and
a storage container comprised of a second fastener, the storage container positioned on the top surface.

13. A utility cart device of claim 12, wherein the second fastener is positioned on a bottom surface of the storage container.

14. A utility cart device of claim 12, wherein a third fastener is positioned on a side surface of the storage container.

15. A utility cart device of claim 12 further comprised of a bottom shelf.

16. A utility cart device of claim 12, wherein a body of the utility cart device is comprised of a body fastener.

17. A utility cart device of claim 16, wherein the body fastener is comprised of a hook.

18. A method of using a utility cart device, the method comprising the following steps:
providing a utility cart device comprised of a body comprised of a top shelf, and at least one storage container;
placing the storage container on a top surface of the top shelf;
placing a part into the storage container; and
removing the storage container from the top surface.

19. A method of using a utility cart device of claim 18 further comprised of a step of attaching the storage container to the top surface via a first fastener of the top surface and a second fastener of the storage container.

20. A method of using a utility cart device of claim 18 further comprised of a step of attaching the storage container to a second storage container via a third fastener on the storage container and a fourth fastener on the second storage container.
